(19) United States
(12) Patent Application Publication
(10) Pub. No.: US 2023/0151268 A1
(43) Pub. Date: May 18, 2023

(54) COMPOSITIONS COMPRISING ENERGY-SENSITIVE ADDUCTS OF ACETYLENIC COMPOUNDS

(71) Applicant: lSP INVESTMENTS LLC, Wilmington, DE (US)

(72) Inventors: Osama M. MUSA, Bedminster, NJ (US); David K. HOOD, Basking Ridge, NJ (US); Amy Victoria HALL, Durham (GB); Jonathan W. STEED, Durham (GB)

(73) Assignee: lSP INVESTMENTS LLC, Wilmington, DE (US)

(21) Appl. No.: 17/918,282

(22) PCT Filed: Apr. 30, 2021
(86) PCT No.: PCT/US21/30227

§ 371 Date: Oct. 11, 2022

Related U.S. Application Data
(60) Provisional application No. 63/019,109, filed on May 1, 2020.

(51) Int. Cl. C09K 9/02; G01T 1/02

(52) U.S. Cl. CPC C09K 9/02; G01T 1/02; C09K 2211/10

(57) ABSTRACT

The invention provides energy-sensitive adducts of acetylenic compounds having at least 25 carbons and at least one substance, compositions comprising these adducts, and industrial applications thereof including radiation dosimetry and the like. The adducts and compositions thereof have sensitivity towards energy derived from sources of radiation such as ionizing radiation, electromagnetic radiation, or heat.

The X-ray structure of a salt of n-butanoic acid and morpholine showing two different hydrogen bonding interactions

### BACKGROUND

### Field of the Invention

The disclosed and/or claimed inventive concept(s) provides energy-sensitive adducts of acetylenic compounds.

### Description of Related Art

In facilities where radiation sources are used, for example, in hospitals where cancer patients receive radiation treatments or in blood banks where blood products are irradiated, various methods are used to quantitatively determine the radiation exposure. The methods practiced include the use of thermoluminescent dosimeters (TLD's), ionization-type radiation detectors, photographic film, and radiochromic materials. TLD's are inconvenient because they require a complicated and time-consuming read-out process. Ionization-type radiation detectors are awkward and unwieldy and require a complicated setup. Photographic film requires a time-consuming chemical processing procedure before read-out. In case of radiochromic materials, the calculation of the dose requires a complex sequence of steps.

Photochromic polyacetylenes responsive to radiation exposure have been disclosed in several U.S. patents, namely U.S. Pat. Nos. 4,066,676; 4,581,315; 3,501,302; 3,501,297; 3,501,303; 3,501,308; 3,772,028; 3,844,791, and 3,954,816. The recording of image or dosage information using these polyacetylene compounds has presented several problems and shortcomings including an inadequate degree of resolution, clarity, color instability of an imaged pattern. Other deficiencies include a relatively slow image development, and, in some cases, the impractical need to image at extremely low temperatures or at excessively high dosage levels.

A preferred radiation sensitive material in radiation dosimeters includes dispersions of crystalline 10,12-pentacosadiynoic acid (PCDA). Subjecting monomeric PCDA crystals to ionizing radiation results in progressive polymerization, the degree of polymerization increasing with radiation dose. The amount of polymerization (and hence, the radiation dose) can be determined by measuring either the optical density or the spectral absorption of the exposed dosimeter. However, it has been found that these parameters also vary with both the temperature of the device when measured as well as the thickness of PCDA dispersion. Maximum accuracy of dose measurement must account for the temperature and thickness effects.

Radiation dosimetry film provides a means for measuring radiation exposure at a point, but its principal utility is in obtaining a two-dimensional map of radiation exposure, i.e. radiation exposure at multiple points in a two-dimensional array. A typical user may measure an 8″×10″ size film at a spatial resolution of 75 dpi, generating a map of radiation doses at 450,000 points. Of course, other resolutions can be used to generate the radiation exposure map.

U.S. Pat. No. 5,637,876 discloses a radiation dosimeter, exemplarily for use in determining a level of radiation to which a patient is subjected during radiation treatment, which comprises a substrate provided with a layer of radiation sensitive material. The radiation sensitive material has an optical density which varies systematically in accordance with the degree of radiation exposure. The dosimeter may take the form of a card or a flexible substrate which is positionable on the patient or other irradiation subject and which is also positionable in, or slidable through a slot in, a dose reader which includes a reflection or transmission densitometer.

The solid state 1,4-addition polymerization of diacetylenes can be initiated by radiation and heat, and results in a conjugated ene-yne polymeric chain. The reaction is thought to only occur if the topochemical parameters of the diacetylene packing are optimal. The first report of topochemical reactivity in the solid state was in an alkene system described by Schmidt in 1964 who suggested that carbon double bonds must be separated by a maximum distance of 4.2 Å for successful polymerization. In 1969, Wegner reported the first example of diacetylene polymerization in the solid state, while 15 years later, Enkelmann proposed strict criteria for diacetylene reactivity, whereby adjacent diacetylene monomers will react when the reactive groups are separated by a C1-C4′ contact distance (d) of ≤3.8 Å, a translational period repeat spacing (r) of ≤4.9 Å, along with an orientation angle (0) to the crystal axis at an optimum value of 45°. The diacetylene polymerization parameters highlight the importance of molecular organization in the topochemical reaction.

The monomer-to-polymer transition is clearly observed by a color change from colorless to blue, due to the rearrangement of the diacetylene monomers to give an ene-yne chromophore. The blue color is due to π-π* transitions in the ordered, conjugated chain with the reorganization of the chains controlling the degree of diacetylene polymerization. Additional external stimuli on the polymerized diacetylene (polydiacetylene) such as extended heating, pH change, treatment with organic solvents, mechanical stress, and ligand-receptor interactions can cause the polydiacetylenes to exhibit a range of colors from blue, to red, to yellow. These chromic changes can be explained by a conformational rearrangement within the polydiacetylene assembly which disrupts the conjugated backbone, causing reduced overlap of the π orbitals, resulting in a widening of the HOMO-LUMO energy gap and hence the polydiacetylene absorbing light at a higher energy.

The commercially important diacetylene, PCDA, is used to provide a colorimetric change in practical chemosensors, biosensors, and dosimeters. Although PCDA is somewhat photoreactive, further tuning of its photo response is of considerable interest, especially for radiation dosimetry applications. Covalent modification offers a viable strategy to PCDA analogues with a tuned photo response.

Since the solid-state reactivity of dialkynes depends on their crystal packing arrangement, a simpler strategy is to address the dialkyne reactivity through modification of non-covalent interactions by cocrystal or salt formation. Whether a cocrystal or salt will form depends on the difference in pKa of the two components. For a cocrystal, the ΔpKa must be <2-3 log units, while salt formation is expected for a greater difference.

Scoville and Shirley in Journal of Applied Polymer Science, 2011, volume 20 (5), 2809-2820, investigate thermochromic changes of PCDA in combination with four aromatic compounds, benzene, furan, thiophene, and cyclopentadiene, with subsequent exposure to UV radiation. Using Raman spectroscopy and solid-state Fluorometry, no differences were observed between benzene, furan, or thiophene from the PCDA itself, with respect to the blue to red color change, which took place from 80° C. to 100° C. However, the addition of cyclopentadiene exhibited the color change at a significantly higher temperature, ranging from 180° C. to 200° C.

Abdel-Fattah et. al. in Radiation Physics and Chemistry, 2012, volume 81 (1), 70-76, investigate the dosimetric characteristics of γ-radiation sensitive labels based on polyvinyl butyral and PCDA. The color intensity of the labels was proportional to the radiation absorbed dose. The useful dose range was 15 Gy-2 kGy depending on PCDA monomer concentration.

It has been found that compounds and compositions according to the disclosed and/or claimed inventive concept(s) have the property of superior color tunability that enable them to be used as radiation-sensitive materials in radio-sensitive devices for detection and measurement of high energy radiation such as chemosensors, biosensors, and dosimeters in several industrial and healthcare applications. These compounds and compositions have excellent energy sensitivity towards a broad range of energy sources such as heat, electromagnetic radiation, ionizing radiation, gamma rays, UV rays, infrared rays, visible radiation, and X-rays.

### SUMMARY

In a first aspect, the disclosed and/or claimed inventive concept(s) provides an energy-sensitive adduct derived from at least one functionalized or unfunctionalized acetylenic compound having at least 25 carbons and at least one substance.

In a second aspect, the disclosed and/or claimed inventive concept(s) provides a composition comprising an energy-sensitive adduct derived from at least one functionalized or unfunctionalized acetylenic compound having at least 25 carbons and at least one substance.

In a third aspect, the disclosed and/or claimed inventive concept(s) provides a radiation-sensitive device for detection and measurement of high energy radiation comprising a radiation dose indicator comprising an energy-sensitive adduct derived from at least one functionalized or unfunctionalized acetylenic compound having at least 25 carbons and at least one substance.

In a fourth aspect, the disclosed and/or claimed inventive concept(s) provides an energy-sensitive adduct derived from 10,12-pentacosadiynoic acid and at least one substance selected from the group consisting of functionalized or unfunctionalized alkyl amines, dialkyl amines, trialkyl amines, quaternary amines, pyridines, azopyridines, bipyridyls, pyrimidines, pyrazines, piperidines, bipiperidines, morpholines, and combinations thereof.

In a fifth aspect, the disclosed and/or claimed inventive concept(s) provides a composition comprising an energy-sensitive adduct derived from 10,12-pentacosadiynoic acid and at least one substance selected from the group consisting of functionalized or unfunctionalized alkyl amines, dialkyl amines, trialkyl amines, quaternary amines, pyridines, azopyridines, bipyridyls, pyrimidines, pyrazines, piperidines, bipiperidines, morpholines, and combinations thereof.

In a sixth aspect, the disclosed and/or claimed inventive concept(s) provides a radiation-sensitive device for detection and measurement of high energy radiation comprising a radiation dose indicator comprising an energy-sensitive adduct derived from 10,12-pentacosadiynoic acid and at least one substance selected from the group consisting of functionalized or unfunctionalized alkyl amines, dialkyl amines, trialkyl amines, quaternary amines, pyridines, azopyridines, bipyridyls, pyrimidines, pyrazines, piperidines, bipiperidines, morpholines, and combinations thereof.

### BRIEF DESCRIPTION OF DRAWINGS

FIG. 1 presents the X-ray structure of a salt of n-butanoic acid and morpholine showing two different hydrogen bonding interactions.

### DETAILED DESCRIPTION

Before explaining at least one aspect of the disclosed and/or claimed inventive concept(s) in detail, it is to be understood that the disclosed and/or claimed inventive concept(s) is not limited in its application to the details of construction and the arrangement of the components or steps or methodologies set forth in the following description or illustrated in the drawings. The disclosed and/or claimed inventive concept(s) is capable of other aspects or of being practiced or carried out in various ways. Also, it is to be understood that the phraseology and terminology employed herein is for the purpose of description and should not be regarded as limiting.

Unless otherwise defined herein, technical terms used in connection with the disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications referenced in any portion of this application are herein expressly incorporated by reference in their entirety to the same extent as if each individual patent or publication was specifically and individually indicated to be incorporated by reference.

All articles and/or methods disclosed herein can be made and executed without undue experimentation based on the present disclosure. While the articles and methods of the disclosed and/or claimed inventive concept(s) have been described in terms of aspects, it will be apparent to those of ordinary skill in the art that variations may be applied to the articles and/or methods and in the steps or in the sequence of steps of the method described herein without departing from the concept, spirit and scope of the disclosed and/or claimed inventive concept(s). All such similar substitutes and modifications apparent to those skilled in the art are deemed to be within the spirit, scope, and concept of the disclosed and/or claimed inventive concept(s).

As utilized in accordance with the disclosure, the following terms, unless otherwise indicated, shall be understood to have the following meanings.

The use of the word “a” or “an” when used in conjunction with the term “comprising” may mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.”

Throughout this application, the term “about” is used to indicate that a value includes the inherent variation of error for the quantifying device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent.

The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B_{Xn}, B_{Xn+1}, or combinations thereof” is intended to include at least one of: A, B_{Xn}, B_{Xn+1}, AB_{Xn}, A B_{Xn+1}, B_{Xn}B_{Xn+1}, or AB_{Xn}B_{Xn+1} and, if order is important in a particular context, also B_{Xn}A, B_{Xn+1}A, B_{Xn+1}B_{Xn}, B_{Xn+1}B_{Xn}A, B_{Xn}B_{Xn+1}A, AB_{Xn+1}B_{Xn}, B_{Xn}AB_{Xn+1}, or B_{Xn+1}AB_{Xn}. Continuing with this example, expressly included are combinations that contain repeats of one or more item or term, such as B_{Xn}B_{Xn}, AAA, MB_{Xn}, B_{Xn}B_{Xn}B_{Xn+1}, AAAB_{Xn}B_{Xn+1}B_{Xn+1}B_{Xn+1}B_{Xn+1}, B_{Xn+1}B_{Xn}B_{Xn}AAA, B_{Xn+1}A B_{Xn}AB_{Xn}B_{Xn}, and so forth. The skilled artisan will understand that typically there is no limit on the number of items or terms in any combination, unless otherwise apparent from the context.

The term “each independently selected from the group consisting of” means when a group appears more than once in a structure, that group may be selected independently each time it appears.

The term “hydrocarbyl” includes straight-chain and branched-chain alkyl, alkenyl, alkynyl, cycloalkyl, cycloalkenyl, aryl groups, and combinations thereof with optional heteroatom(s). A hydrocarbyl group may be mono-, di- or polyvalent.

The term “alkyl” refers to a functionalized or unfunctionalized, monovalent, straight-chain, branched-chain, or cyclic C₁-C₆₀ hydrocarbyl group optionally having one or more heteroatoms. In one non-limiting embodiment, an alkyl is a C₁-C₄₅ hydrocarbyl group. In another non-limiting embodiment, an alkyl is a C₁-C₃₀ hydrocarbyl group. Non-limiting examples of alkyl include methyl, ethyl, n-propyl, isopropyl, n-butyl, isobutyl, tert-butyl, n-pentyl, isopentyl, n-hexyl, n-heptyl, n-octyl, 2-ethylhexyl, tert-octyl, iso-norbornyl, n-dodecyl, tert-dodecyl, n-tetradecyl, n-hexadecyl, n-octadecyl, n-eicosyl, cyclobutyl, cyclopentyl, cyclohexyl, and the like. The definition of “alkyl” also includes groups obtained by combinations of straight-chain, branched-chain and/or cyclic structures.

The term “aryl” refers to a functionalized or unfunctionalized, monovalent, aromatic hydrocarbyl group optionally having one or more heteroatoms. The definition of aryl includes carbocyclic and heterocyclic aromatic groups. Non-limiting examples of aryl groups include phenyl, naphthyl, indenyl, indanyl, azulenyl, fluorenyl, anthracenyl, furyl, thienyl, pyridyl, pyrrolyl, oxazolyl, thiazolyl, imidazolyl, pyrazolyl, 2-pyrazolinyl, pyrazolidinyl, isoxazolyl, isothiazolyl, 1,2,3-oxadiazolyl, 1,2,3-triazolyl, 1,3,4-thiadiazolyl, pyridazinyl, pyrimidinyl, pyrazinyl, 1,3,5-triazinyl, 1,3,5-trithianyl, indolizinyl, indolyl, isoindolyl, 3H-indolyl, indolinyl, benzo[b]furanyl, 2,3-dihydrobenzofuranyl, benzo[b]thiophenyl, 1H-indazolyl, benzimidazolyl, benzthiazolyl, purinyl, 4H-quinolizinyl, isoquinolinyl, cinnolinyl, phthalazinyl, quinazolinyl, quinoxalinyl, 1,8-naphthridinyl, pteridinyl, carbazolyl, acridinyl, phenazinyl, phenothiazinyl, phenoxyazinyl, pyrazolo[1,5-c]triazinyl, and the like.

The term “aralkyl” refers to an alkyl group comprising one or more aryl substituent(s) wherein “aryl” and “alkyl” are as defined above. Non-limiting examples of aralkyl groups include benzyl, 2-phenyl-ethyl, 3-phenyl-propyl, 4-phenyl-butyl, 5-phenyl-pentyl, 4-phenylcyclohexyl, 4-benzylcyclohexyl, 4-phenylcyclohexylmethyl, 4-benzylcyclohexylmethyl, and the like.

The term “alkylene” refers to a functionalized or unfunctionalized, divalent, straight-chain, branched-chain, or cyclic C₁-C₄₀ hydrocarbyl group optionally having one or more heteroatoms. In one non-limiting embodiment, an alkylene is a C₁-C₃₀ group. In another non-limiting embodiment, an alkylene is a C₁-C₂₀ group. Non-limiting examples of alkylene groups include:

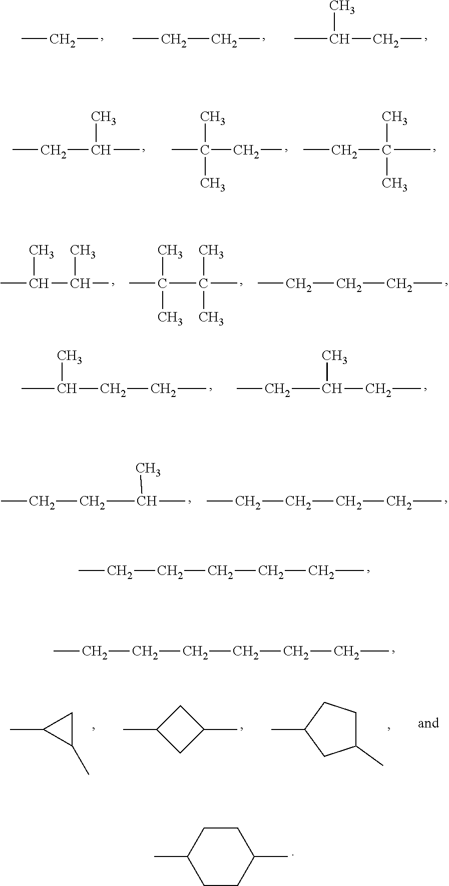

The term “arylene” refers to a functionalized or unfunctionalized, divalent, aromatic hydrocarbyl group optionally having one or more heteroatoms. The definition of arylene includes carbocyclic and heterocyclic groups. Non-limiting examples of arylene groups include phenylene, naphthylene, pyridinylene, and the like.

The term “heteroatom” refers to oxygen, nitrogen, sulfur, silicon, phosphorous, or halogen. The heteroatom(s) may be present as a part of one or more heteroatom-containing functional groups. Non-limiting examples of heteroatom-containing functional groups include ether, hydroxy, epoxy, carbonyl, carboxamide, carboxylic ester, carboxylic acid, imine, imide, amine, sulfonic, sulfonamide, phosphonic, and silane groups. The heteroatom(s) may also be present as a part of a ring such as in heteroaryl and heteroarylene groups.

The term “halogen” or “halo” refers to Cl, Br, I, or F.

The term “ammonium” includes protonated NH₃ and protonated primary, secondary, and tertiary organic amines.

The term “functionalized” with reference to any moiety refers to the presence of one or more functional groups in the moiety. Various functional groups may be introduced in a moiety by way of one or more functionalization reactions known to a person having ordinary skill in the art. Non-limiting examples of functionalization reactions include: alkylation, epoxidation, sulfonation, hydrolysis, amidation, esterification, hydroxylation, dihydroxylation, amination, ammonolysis, acylation, nitration, oxidation, dehydration, elimination, hydration, dehydrogenation, hydrogenation, acetalization, halogenation, dehydrohalogenation, Michael addition, aldol condensation, Canizzaro reaction, Mannich reaction, Clasien condensation, Suzuki coupling, and the like. In one non-limiting embodiment, the term “functionalized” with reference to any moiety refers to the presence of one more functional groups selected from the group consisting of alkyl, alkenyl, hydroxyl, carboxyl, halogen, alkoxy, amino, imino, and combinations thereof, in the moiety.

The term “monomer” refers to a small molecule that chemically bonds during polymerization to one or more monomers of the same or different kind to form a polymer.

The term “polymer” refers to a large molecule comprising one or more types of monomer residues (repeating units) connected by covalent chemical bonds. By this definition, polymer encompasses compounds wherein the number of monomer units may range from very few, which more commonly may be called as oligomers, to very many. Non-limiting examples of polymers include homopolymers, and non-homopolymers such as copolymers, terpolymers, tetrapolymers and the higher analogues. The polymer may have a random, block, and/or alternating architecture.

The term “homopolymer” refers to a polymer that consists essentially of a single monomer type.

The term “non-homopolymer” refers to a polymer that comprises more than one monomer types.

The term “copolymer” refers to a non-homopolymer that comprises two different monomer types.

The term “terpolymer” refers to a non-homopolymer that comprises three different monomer types.

The term “branched” refers to any non-linear molecular structure. The term includes both branched and hyper-branched structures.

All percentages, ratio, and proportions used herein are based on a weight basis unless other specified.

In a first aspect, the disclosed and/or claimed inventive concept(s) provides an energy-sensitive adduct derived from at least one functionalized or unfunctionalized acetylenic compound having at least 25 carbons and at least one substance.

In one non-limiting embodiment, the functionalized or unfunctionalized acetylenic compound according to the disclosed and/or claimed inventive concept(s) comprises at least one acetylene moiety and optionally at least one reactive moiety. In another non-limiting embodiment, the functionalized or unfunctionalized acetylenic compound according to the disclosed and/or claimed inventive concept(s) comprises at least one acetylene moiety and at least one reactive moiety.

In one non-limiting embodiment, the functionalized or unfunctionalized acetylenic compound according to the disclosed and/or claimed inventive concept(s) comprises at least two acetylene moieties and optionally at least one reactive moiety. In another non-limiting embodiment, the functionalized or unfunctionalized acetylenic compound according to the disclosed and/or claimed inventive concept(s) comprises at least two acetylene moieties and at least one reactive moiety.

In one non-limiting embodiment, the reactive moiety is selected from the group consisting of functionalized or unfunctionalized carboxyl, hydroxy, epoxy, amino, aldehyde, keto, amide, ester, nitrile, (meth)acryloyl, urethane, ether, and combinations thereof.

In one non-limiting embodiment, the reactive moiety is a functionalized or unfunctionalized carboxyl moiety.

In one non-limiting embodiment, the functionalized or unfunctionalized acetylenic compound according to the disclosed and/or claimed inventive concept(s) is selected from the group consisting of pentacosadiynoic acids, hexacosadiynoic acids, heptacosadiynoic acids, octacosadiynoic acids, nonacosadiynoic acids, triacontanediynoic acids, and combinations thereof.

In one non-limiting embodiment, the functionalized or unfunctionalized acetylenic compound is 10,12-pentacosadiynoic acid.

In one non-limiting embodiment, the substance according to the disclosed and/or claimed inventive concept(s) is selected from the group consisting of polar, nonpolar, organic, inorganic, and organometallic substances.

In one non-limiting embodiment, the substance according to the disclosed and/or claimed inventive concept(s) is selected from the group consisting of functionalized or unfunctionalized aliphatic, alicyclic, heterocyclic, aromatic, heteroaromatic, olefinic, and polyolefinic hydrocarbons.

In one non-limiting embodiment, the substance according to the disclosed and/or claimed inventive concept(s) is selected from the group consisting of organic acids, organic bases, inorganic acids, inorganic bases, complex formers, crystal formers, cocrystal formers, and combinations thereof.

In one non-limiting embodiment, the substance according to the disclosed and/or claimed inventive concept(s) is selected from the group consisting of functionalized or unfunctionalized aliphatic amines, alicyclic amines, heterocyclic amines, aromatic amines, heteroaromatic amines, and combinations thereof.

In one non-limiting embodiment, the substance according to the disclosed and/or claimed inventive concept(s) is selected from the group consisting of functionalized or unfunctionalized alkyl amines, dialkyl amines, trialkyl amines, quaternary amines, pyridines, azopyridines, bipyridyls, pyrimidines, pyrazines, piperidines, bipiperidines, morpholines, and combinations thereof.

Non-limiting, yet particular examples of organic bases include 4,4′-azopyridine, 4,4′-bipyridyl, trans-1,2-bis(4-pyridyl)ethylene, 4,4′-bipiperidine, morpholine, diethylamine, n-butylamine, and combinations thereof. Other suitable examples of organic bases can be found in ULLMANN's Encyclopedia of Industrial Chemistry, 7^{th} Edition, 2002, Wiley-VCH Verlag GmbH & Co. KGaA, the contents of which are herein incorporated by reference in its entirety.

In one non-limiting embodiment, the substance according to the disclosed and/or claimed inventive concept(s) is selected from the group consisting of inorganic bases.

In one non-limiting embodiment, the substance according to the disclosed and/or claimed inventive concept(s) is selected from the group consisting of hydrides, oxides, hydroxides, cyanides, carbonates, and bicarbonates of alkali and alkaline earth metal elements, and combinations thereof.

Other suitable examples of inorganic bases can be found in ULLMANN's Encyclopedia of Industrial Chemistry, 7^{th} Edition, 2002, Wiley-VCH Verlag GmbH & Co. KGaA, the contents of which are herein incorporated by reference in its entirety

In one non-limiting embodiment, the energy-sensitive adduct derived from at least one functionalized or unfunctionalized acetylenic compound having at least 25 carbons and at least one substance according to the disclosed and/or claimed inventive concept(s) exhibits an enhanced energy-sensitivity compared to the acetylenic compound in absence of said substance.

In another non-limiting embodiment, the energy-sensitive adduct derived from at least one functionalized or unfunctionalized acetylenic compound having at least 25 carbons and at least one substance according to the disclosed and/or claimed inventive concept(s) exhibits a reduced energy-sensitivity compared to the acetylenic compound in absence of said substance.

In one non-limiting embodiment, the energy-sensitive adduct according to the disclosed and/or claimed inventive concept(s) is sensitive to energy derived from ionizing radiation, electromagnetic radiation, or heat. In another non-limiting embodiment, the energy-sensitive adduct according to the disclosed and/or claimed inventive concept(s) is sensitive to ionizing radiation comprising gamma rays or X-rays. In yet another non-limiting embodiment, the energy-sensitive adduct according to the disclosed and/or claimed inventive concept(s) is sensitive to electromagnetic radiation comprising visible, ultraviolet, or infrared radiation.

In one non-limiting embodiment, the energy-sensitive adduct according to the disclosed and/or claimed inventive concept(s) is in the form of a salt, cocrystal, polymorph, or an amorphous solid dispersion. In another non-limiting embodiment, the energy-sensitive adduct according to the disclosed and/or claimed inventive concept(s) is in the form of a salt or cocrystal.

In a second aspect, the disclosed and/or claimed inventive concept(s) provides a composition comprising an energy-sensitive adduct derived from at least one functionalized or unfunctionalized acetylenic compound having at least 25 carbons and at least one substance.

In one non-limiting embodiment, the composition comprising an energy-sensitive adduct derived from at least one functionalized or unfunctionalized acetylenic compound having at least 25 carbons and at least one substance comprises at least one functional ingredient selected from the group consisting of binders, plasticizers, activators, solvents, secondary energy-sensitive materials, dyes, converter materials, surfactants, catalysts, and combinations thereof.

Non-limiting, yet particular examples of binders include homopolymers, copolymers, graft-copolymers, block copolymers, polymeric alloys, and mixtures thereof. A large number of monomers and oligomers can be used to make these polymeric binders. Non-limiting, yet particular examples of such monomers include unsaturated monomers such as olefins, vinyls, acrylates, and (meth)acrylates such as methyl methacrylate, methyl acrylate, styrene, acrylic acid, butane diol 1,4-dimethacrylate, diethylene glycol diacrylate, diethylene glycol dimethacrylate, ethylene glycol dimethacrylate, hexanediol-1,6-dimethacrylate, methyl styrene pentaerylthriol triacrylate, polyethylene glycol dimethacrylate, polypropylene glycol dimethacrylate, triethylene glycol dimethacrylate, 4-(vinyloxy) butyl benzoate, bis[4-(vinyloxy)butyl] adipate, bis[4-(vinyloxy)butyl] succinate, 4-(vinyloxymethyl)cyclohexylmethyl, bis[4-(vinyloxy)butyl] isophthalate, bis[4-(vinyloxymethyl)cyclohexylmethyl], tris[4-(vinyloxy)butyl] trimellitate, 4-(vinyloxy)butyl stearate, bis[4-(vinyloxy)butyl] hexanediylbiscarbamate, bis[[4-[(vinyloxy)methyl]cyclohexyl]methyl], bis[[4-[(vinyloxy)methyl]cyclohexy]methyl], bis[4-(vinyloxy)butyl] (4-methyl-1,3-phenylene), and combinations thereof.

Non-limiting, yet particular examples of solvents include high boiling solvents such as butoxy-2-ethylstearate, butyrolactone, diethyl fumarate, dimethyl maleate, dimethylcarbonate, dioctyl phthalate, ethylene glycol dimethyl ether ethyl salicylate, polyethylene glycol dimethylether, propylene carbonate, triacetin, benzyl ether, dodecyl-1,2-methyl pyrrolidone, ethoxyethylacetate, ethylene glycol diacetate, ethyltrichloroacetate, methylpyrrolidone, methyl sulfoxide, polyethylene glycols of different molecular weight, dimethylformamide, cyclohexane, p-dioxane, tetrahydrofuran and p-xylene.

Non-limiting, yet particular examples of dyes include new fuschin cyanide, hexahydroxy ethyl violet cyanide, pararose aniline cyanide, leuco crystal violet, leuco malachite green, and carbinol dyes such as malachite green base and p-roseaniline base, and those described in U.S. Pat. Nos. 2,877,169; 3,079,955; and 4,377,751, each of which disclosure is herein incorporated by reference in its entirety. Other examples of dyes can be found in the patent EP1529089 B1 that is herein incorporated by reference in its entirety.

Non-limiting, yet particular examples of activators include a halocarbon, a halonium, a sulfonium, ethyl trichloroacetate, heptachloropropane, ethyltrichloroacetate, chloroacetic acid, chloropropionic acid, hexachlorocyclohexane, methyltrichloroacetimidate, trichloroacetic acid, trichloroacetamide, trichloro ethanol, trichloro methyl benzyl acetate, trichloro methyl propanol hydrate, trichloro propane, chlorinated polymers, diphenyliodinium iodide, diphenyliodinium hexafluoroarsenate, diphenyliodinium chloride, trimethylsulfonium iodide and triphenylsulfonium hexafluoroantimonate.

In a third aspect, the disclosed and/or claimed inventive concept(s) provides a radiation-sensitive device for detection or measurement of radiation comprising a radiation dose indicator comprising an energy-sensitive adduct derived from at least one functionalized or unfunctionalized acetylenic compound having at least 25 carbons and at least one substance.

In a fourth aspect, the disclosed and/or claimed inventive concept(s) provides an energy-sensitive adduct derived from 10,12-pentacosadiynoic acid and at least one substance selected from the group consisting of functionalized or unfunctionalized alkyl amines, dialkyl amines, trialkyl amines, quaternary amines, pyridines, azopyridines, bipyridyls, pyrimidines, pyrazines, piperidines, bipiperidines, morpholines, and combinations thereof.

In a fifth aspect, the disclosed and/or claimed inventive concept(s) provides a composition comprising an energy-sensitive adduct derived from 10,12-pentacosadiynoic acid and at least one substance selected from the group consisting of functionalized or unfunctionalized alkyl amines, dialkyl amines, trialkyl amines, quaternary amines, pyridines, azopyridines, bipyridyls, pyrimidines, pyrazines, piperidines, bipiperidines, morpholines, and combinations thereof.

In a sixth aspect, the disclosed and/or claimed inventive concept(s) provides a radiation-sensitive device for detection and measurement of high energy radiation comprising a radiation dose indicator comprising an energy-sensitive adduct derived from 10,12-pentacosadiynoic acid and at least one substance selected from the group consisting of functionalized or unfunctionalized alkyl amines, dialkyl amines, trialkyl amines, quaternary amines, pyridines, azopyridines, bipyridyls, pyrimidines, pyrazines, piperidines, bipiperidines, morpholines, and combinations thereof.

High energy radiations are used for a variety of applications, such as curing of coatings and cross-linking of polymers, recording images and information, radiography, nondestructive testing, and diagnostic and radiation therapy wherein their exposure needs to be monitored. In non-limiting, yet particular embodiments, the radiation-sensitive device according to the disclosed and/or claimed inventive concept(s) includes materials in the form of coatings, films, fiber, rods, plaques, or blocks. General methods of preparation of radiation-sensitive devices can be found in the patent EP1529089 B1 that is herein incorporated by reference in its entirety.

Additional insight into the properties, functionality and application(s) of the adducts and compositions according to the disclosed and/or claimed inventive concepts is disclosed in Hall et al. in Chemical Science, 2020, volume 11, 8025-8035, the disclosure of which is herein incorporated by reference in its entirety.

The adducts and compositions according to the disclosed and/or claimed inventive concept(s) may be prepared according to the examples set out below. These examples are presented herein for purposes of illustration of the disclosed and/or claimed inventive concept(s) and are not intended to be limiting, for example, the preparations of the adducts and compositions.

### EXAMPLES

### Example 1: Preparation and Characterization of PCDA Co-Crystals

Grinding PCDA (1) and 4,4′-azopyridine (2) in a Retsch MM 200 mixer mill for 1 hour in a 2:1 ratio, respectively, gave a powder of cocrystal 1₂·2, which was characterized by PXRD and used for seeding the cocrystallization of 1 and 2 in acetone. After the evaporation of solvent at room temperature for one week, plate-shaped crystals of 1₂·2 formed and were analyzed by single crystal X-ray diffraction (SC-XRD). The structure of 1₂·2 reveals a 2:1 stoichiometry with the diacetylene substituents in anti-conformation, analogous to the structure of 1, with OH . . . N hydrogen bonds from the carboxylic acid protons of 1 to the pyridyl nitrogen atoms of 2. The O . . . N distance of 2.677(4) Å is consistent with a strong, carboxylic acid OH pyridyl hydrogen bond. The carboxylic acid proton was located experimentally and is situated on the oxygen atom of the carboxylic acid, ruling out the possibility of salt formation. The unit cell of 1₂·2 has a shorter crystallographic c-axis of 39.920(2) Å compared to 1 itself (by a considerable 6.87 Å) implying a more slanted orientation of the lamellar structure. Compared to 1, the cocrystal 1₂·2 also has a significantly shorter inter-alkyne C1-C4′ distance of 3.633(1) Å, however, the tilt angle of 1 in the cocrystal is greater than the optimum value at 48.4°, along with a translational repeat distance outside of the desired range for topochemical reactivity at 5.354(1) Å.

Along with SC-XRD, 12·2 was characterized by Differential Scanning calorimetry (DSC) which displayed a melting onset temperature of 69° C., which is between the melting temperatures of the individual components. The Fourier-transform infrared (FTIR) spectrum displays a hydrogen-bonded carbonyl stretching band at 1695 cm-1, compared to 1690 cm-1 in pure 1 implying slightly weaker hydrogen bonding. The cocrystal displays significant anisotropic thermal expansion along the c-axis which increases from 39.33 Å to 40.99 Å between 120 and 273 K. The differences in the unit cell made the calculated and experimental PXRD data difficult to compare, although it is clear that the single crystal studied is representative of the bulk material.

Two further cocrystals 1₂·3 (3=4,4′-bipyridyl) and 1₂·4 (4=trans-1,2-bis(4-pyridyl)ethylene) were synthesized from 4,4′-bipyridyl and trans-1,2-bis(4-pyridyl)ethylene respectively by grinding the coformers with PCDA in a 2:1 ratio for 45 minutes in a mixer mill, to yield the cocrystal in powder form. Samples were characterized by PXRD and then used in seeded crystallizations in acetone. These experiments gave plates of 1₂·3 and 1₂·4, respectively, after the evaporation of solvent at room temperature for one week. A single crystal of 1₂·3 was analyzed at the 119 beamline at the Diamond Light Source at 100 K, while crystals of 1₂·4 were analyzed on a Bruker D8 Venture diffractometer at 120 K. The two materials are isostructural and crystallize in the monoclinic space group P21/c. The X-ray structures of cocrystals 1₂·3 and 1₂·4 consist of hydrogen bonds between the carboxylic acid hydrogen atom of 1 and the pyridyl nitrogen atom of the coformer at an O . . . N distance of 2.652 Å in 1₂·3 and 2.6579 Å in 1₂·4. Interestingly the dialkyne moieties in both structures adopt a syn-conformation, in contrast to the anti-conformation in 1 and 1₂·2 indicating that subtle modification of conformed can have a significant effect on crystal packing mode and hence photoreactivity. The ethylene bond of 1₂·4 is disordered over two positions. The syn conformation of the dialkyne substituents allows an interdigitated, bilayer packing arrangement which translates to the much longer crystallographic c axes which encompass four folded molecules in the cocrystals of 3 and 4 as opposed to two extended molecules in 1₂·2.

The differential scanning calorimetry (DSC) thermogram of 1₂·3 displays a melt onset endotherm of 77.8° C. (compared to the coformer melt temperatures for 1 and 3 of 67° C. and 114° C., respectively), while 1₂·4 exhibits a melting onset temperature of 75.8° C., compared to 150° C. for 4. The FTIR spectra for these cocrystals display hydrogen-bonded carbonyl stretch at 1683 cm⁻¹ and 1688 cm⁻¹ respectively, compared to 1690 cm⁻¹ in pure 1, implying slightly stronger hydrogen bonding. In a similar way to 1₂·2, cocrystals 1₂·3 and 1₂·4 show considerable anisotropic thermal expansion on warming. This makes the calculated PXRD patterns appear somewhat different to the room temperature experimental patterns.

### Example 2: Preparation and Characterization of PCDA Salts

Cocrystals of PCDA with bifunctional coformers 2-4 appear to give structures that are unlikely to be photoreactive based on their topochemical metrics. As a result, we examined both mono- and bifunctional coformers with higher basicity intended to deprotonate the PCDA acid functionality and hence alter the hydrogen bonding pattern and change the consequent stacking of the PCDA units. Salt formation was undertaken with a bifunctional diamine (5), a cyclic amine (6), a linear secondary amine (7), and a linear terminal amine (8). PCDA and compounds 5-8 (5=4,4′-bipiperidine, 6=morpholine, 7=diethylamine, and 8=n-butylamine) were mechanochemically ground in a mixer mill to give a range of new salt materials as indicated by FTIR analysis. The carboxylate asymmetric carbonyl stretching modes proved to be at lower wavenumbers than in the free acid (1, 1690 cm⁻¹) with a carbonyl stretch at 1653 cm⁻¹ in 1₂·5 and 1·6, 1627 cm⁻¹ in 1₂·7, and 1649 cm⁻¹ in 1·8, suggesting stronger hydrogen bonding in the salts than the cocrystals and a delocalized carboxylate anion structure. The X-ray structure of 1₂·5 reveals a salt with two anions of 1 and a dication of double protonated 5 in a 2:1 stoichiometry, respectively, consisting of NH . . . O hydrogen bonds from the amine hydrogen atom of 5 and the oxygen atom of 1, at an N . . . O distance of 2.717(1) Å. The salt 1₂·5 crystallizes with the same symmetry as 1 and 1₂·2 in the space group PT, with the crystallographic c-axis at the shortest observed so far at 23.0041(15) Å. The C1-C4′ inter-alkyne distance between adjacent molecules of 1 is 3.760(2) Å, which is within the topochemical postulate for the reactivity of diacetylenes (≤3.8 Å), however, the tilt angle of 1 in the salt cocrystal is below the desired value (45°) at 24.1°, and the translational repeat distance of 5.577(2) Å is outside the maximum distance for this parameter (≤4.9 Å) again suggesting limited photoreactivity.

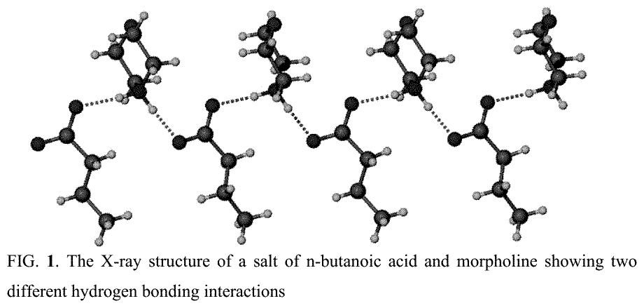

The morpholinium salt 1·6 was crystallized by the slow evaporation of acetone at room temperature, however, due to poor crystal quality after repeated crystallization attempts, no SC-XRD analysis of 1·6 could be undertaken. To model the interactions between the two components, the synthesis of the butanoic acid (BuA) salt of 6 was undertaken. Large single crystals of BuA 6 formed from equimolar amounts of reagents in a sealed flask allowed to stand overnight. The X-ray structure as shown in FIG. 1 reveals a salt with a butanoate anion and protonated morpholinium cation. The structure involves two unique NH . . . O hydrogen bonding interactions with N . . . O distances of 2.673(1) Å and 2.732(1) Å. Based on the similar pKₐ of 1 and butanoic acid it is likely that 1·6 is also a salt with similar head-group structure.

Salts of PCDA with diethylamine and n-butylamine crystallized by slow evaporation of acetone solutions at room temperature. Surprisingly the crystals are highly colored purple and blue, respectively, consistent with facile photopolymerisation. However, the X-ray structure determinations reveal salts of unpolymerized PCDA and hence the coloration is likely to be a surface effect. Indeed, cutting a single crystal in half revealed a colorless inner core. The structure of the diethylammonium salt proved to be a salt cocrystal that also includes a neutral molecule of 1, with formula 1₂·7. The butylammonium compound is a 1:1 salt of formula 1·8. The structure adopts a stacked bilayer arrangement. In 1₂·7 hydrogen bonding occurs from the ammonium NH hydrogen atoms to the carbonyl oxygen of 1, with an N . . . O distance of 2.737(1) Å. The carboxylic acid group of the neutral PCDA hydrogen bonds to the carboxylate functionality on the PCDA anion with a very short O . . . O distance of 2.444(1) Å (the additional hydrogen atom present between PCDA and the PCDA anion is disordered). In the 1:1 salt 1·8, there are three different hydrogen bond interactions form from the NH₃⁺ cation to the carboxylate oxygen atoms of the PCDA anion, with NH . . . O distances of 2.671(1) Å, 2.725(1) Å, and 2.784(1) Å. The 1₂·7 structure also has a large c-axis of 57.520(4) Å, which is the longest c-axis of all the structures studied reflecting the linear, parallel arrangement of the PCDA components. Salts 1₂·7 and 1·8 have similar C1-C4′ inter-alkyne distances of 3.776(2) Å and 3.779(1) Å, respectively, with tilt angles of 41.9° and 43.7°, and translational repeat distances of 4.644(3) Å and 4.593(1) Å. For these two salts, all three values are well within the optimum values of the topochemical postulate, and they are therefore are expected to show significant photoreactivity, consistent with the spontaneous surface coloration of the crystals.

DSC analyses of the PCDA salts of 5-8 reveal melt onset endotherms of 111° C. for 1₂·5 (compared to 67° C. and 170° C. for the parent components 1 and 5, respectively). This relatively high value likely reflects the fact that proton transfer has occurred as well as the higher melting point of the bipiperidine conformer. The morpholinium salt 1·6 has a low melting onset of 54° C. consistent with the fact that morpholine is a liquid at room temperature (it boils at 128° C.). The DSC thermogram of 1₂·7 exhibits a melt onset endotherm of 50.7° C., in comparison to the boiling temperature of 55° C. for 7, while 1·8 displays a melt onset endotherm at 63.1° C., with the salt former 8 boiling at 77° C.

Cocrystal and Salt Response to UV and X-Rays

The powder of each cocrystal and salt was placed on filter paper in a dark box and exposed to a 6-Watt handheld UV light at 254 nm for up to 24 hours. It is known that the azobenzene coformer 2 itself undergoes photoisomerization to the cis form when irradiated at 365 nm and so 1₂·2 was also irradiated at this wavelength in order to probe photoresponse of the conformer component within the cocrystal. While PCDA powder itself gradually darkens from a white to deep blue upon irradiation, all of the cocrystals with coformers 2-4 appear to be photostable despite the close proximity of the dialkyne functionalities, which are within the distance specified by the topochemical postulate. However, the tilt angles of 1 in the cocrystals, and the translational repeat distances of the cocrystals are outside of the desired values. The irradiated cocrystals were analyzed by PXRD, solid-state CP-MAS ¹³C NMR spectroscopy, and FTIR spectroscopy. This data confirmed that the cocrystal samples remain essentially unchanged after irradiation. This data also showed that even the deep blue irradiated sample of PCDA undergoes <1% photopolymerisation, implying that the very striking color observed is only a surface effect and the radiation is not penetrating the bulk of the sample. The azobenzene cocrystal also does not undergo significant change when irradiated at 365 nm. This lack of cis/trans photoreactivity of the azobenzene in 1₂·2 implies that the solid-state environment of the cocrystal stabilizes the trans isomer. The salts of monofunctional ammonium cations are all highly photoactive. Significant visual color change occurs after just five minutes of irradiation for the salts 1·6, 1₂·7 and 1·8. Signals assigned to photopolymerized material are clearly visible by CP-MAS ¹³C NMR spectroscopy. Salt 1₂·7 shows the greatest sensitivity towards UV radiation by CP-MAS ¹³C NMR spectroscopy with the most significant change occurring in the alkene region (100-140 ppm) of the spectrum corresponding to the ene-yne photopolymer functionality. However, even in these systems the conversion is slow, and the sharpness of the NMR resonances imply a relatively low degree of oligomerization. This kind of slow reactivity reflects the solid-state nature of the process resulting in poor radiation penetration into the bulk of the sample. However, this gradual response is desirable in dosimetry applications making these materials of considerable interest. The significant photoreactivity of 1₂·7 and 1·8 is consistent with the crystal packing revealed by their structures, which both show parameters within the range specified by the topochemical postulate.

FTIR analysis of the salt cocrystals after irradiation shows that salts 1·6, 1₂·7, and 1·8 begin to lose their volatile coformers after prolonged UV exposure and revert to free carboxylic acids. This is evidenced by the decrease in intensity of the carboxylate asymmetric stretch band v_{asymm}(CO₂) of the salt (1653 cm⁻¹ in 1·6, 1627 cm⁻¹ in 1₂·7, and 1649 cm⁻¹ in 1·8) and the emergence of a free acid peak at 1690 cm⁻¹ close to the value of PCDA as the sample is irradiated. The effect is highly pronounced for the morpholinium salt 1·6 which reverts to free acid after just one hour while 7 and 8 begin to separate from their respective salts after one day of irradiation. The resulting carboxylic acid is a mixture of free PCDA and photopolymer. These findings are also supported by PXRD analysis of the irradiated salts. Interestingly, given the very limited photoreactivity of PCDA itself, salt formation followed by removal of the amine in this way gives an interesting route to the free acid photopolymer and hence transient amine complexation effectively catalyzes the photopolymerisation reaction of PCDA itself.

In addition to UV irradiation the effect of X-ray on PCDA and its derivatives was also analyzed. Free PCDA (1) was irradiated with 100 Gy of X-ray radiation and analyzed by Raman spectroscopy. This revealed a clear ene-yne polymer alkyne band at 2098.8 cm⁻¹ with a small residual dialkyne band at 2253.3 cm⁻¹. The enhanced appearance of the 2098.8 cm⁻¹ band despite the very limited photoreactivity of free 1 is a reflection of a pre-resonance Raman effect since the excitation wavelength of the laser 785 nm overlaps with the absorption band of the photopolymer, resulting in significant enhancement of the chromophore Raman bands. This is consistent with the visual observation of some blue coloration despite the ¹³C CP MAS-NMR data that indicate a very low degree of bulk conversion. In contrast, when all three cocrystals with coformers 2-4 were irradiated with 10 Gy of X-ray radiation they showed very little photoreactivity, as evidenced by the low intensity peaks in the conjugated ene-yne region (approx. 2100 cm⁻¹) that exists both before and after irradiation. Cocrystal 1₂·2 has a small ene-yne band present at 2100.4 cm⁻¹ compared to the other two cocrystals likely arising from small amounts of 1 photopolymer present as a contaminant in the starting PCDA. Similar to the cocrystals, salt 1₂·5 displays a band at 2258.4 cm⁻¹ assigned to unreacted dialkyne even after 100 Gy of X-ray irradiation which further reinforces that the salt is photostable. The small ene-yne photopolymer band at 2100.3 cm⁻¹ is likely to arise from small amounts of photopolymerized PCDA impurities. On the other hand, salt 1·6 shows impressive sensitivity X-ray radiation as indicated by the presence of the significant ene-yne band at 2088.1 cm⁻¹. This band is significantly red-shifted compared to photopolymerized PCDA, indicating a more planar, conjugated conformation of the chromophore. This is in contrast to 1 alone which exhibits torsional strain on the it-bonds of the chromophore when irradiated.⁶⁸ Salt 1·6 also shows significantly more visual color change upon irradiation compared to 1 alone. It is likely that the increased hydrogen bonding in the salt brings the monomers of 1 in a closer spatial arrangement and hence makes it more photosensitive. After 100 Gy of X-ray irradiation, salt 1₂·7 also displays a prominent photopolymer alkyne band at 2097.7 cm⁻¹ with minimal residual dialkyne signal. Solid-state NMR results indicate about 53% polymerization, however the Raman signal for the colorless monomer is almost invisible. Interestingly in the Raman spectrum of 1₂·7, the breadth of the ene-yne band, and the presence of an additional alkene peak at 1500 cm⁻¹ at slightly higher wavenumber than the typical major 1445 cm⁻¹ alkene band indicates multiple conformations of the polymerized material, and implies some structural differences in the resulting chromophore suggesting that multiple conformations of the polymerized salt exist. For 1·8, Raman analysis of the 100 Gy X-ray irradiated sample shows that the salt gradually photopolymerizes and has a similar radiation sensitivity as 1 alone, with an ene-yne band at 2098.1 cm⁻¹. Additionally, for the photosensitive salts, the C-H wagging progressions arising between 1300 cm⁻¹ and 1150 cm⁻¹ from the polymer side chains of 1 in the salts change with irradiation to suggest a changed conformational structure when compared to the lithium salt. The change of the side chain conformation is due to difference in phase angles of coupled oscillations between methylene groups. These differences in C-H wagging progressions can be used as an additional conformational tool for detecting the presence of a PCDA polymer. Close examination of the differences in frequency within the wagging mode progressions may also indicate stresses on the side chains due to their close approach to each other as the polymer is formed. Interestingly the positions of the ene-yne alkyne bands in the irradiated diethylammonium and butylammonium salts of around 2100 cm⁻¹ contrast sharply with the value of 2066.3 cm⁻¹ obtained for commercial lithium PCDA. This significantly red-shifted value implies a much more planar ‘ordered’ chromophore in the lithium salt and hence while the commercial material exists in an ordered ‘blue state’ the use of the organic salt-formers give a less ordered ‘red state’ photopolymer. The value of 2088 cm⁻¹ for the morpholinium salt is somewhere in between and implies that the polymer ordering and hence, potentially, color may be tunable.

What we claim is:

1. An energy-sensitive adduct derived from at least one functionalized or unfunctionalized acetylenic compound having at least 25 carbons and at least one substance.

2. The energy-sensitive adduct according to claim 1 wherein said functionalized or unfunctionalized acetylenic compound comprises at least one acetylene moiety and optionally at least one reactive moiety.

3. The energy-sensitive adduct according to claim 2 wherein said reactive moiety is selected from the group consisting of functionalized or unfunctionalized carboxyl, hydroxy, epoxy, amino, aldehyde, keto, amide, ester, nitrile, (meth)acryloyl, urethane, ether, and combinations thereof.

4. The energy-sensitive adduct according to claim 3 wherein said reactive moiety is a functionalized or unfunctionalized carboxyl moiety.

5. The energy-sensitive adduct according to claim 2 wherein said functionalized or unfunctionalized acetylenic compound comprises at least two acetylene moieties and at least one reactive moiety.

6. The energy-sensitive adduct according to claim 5 wherein said functionalized or unfunctionalized acetylenic compound is selected from the group consisting of pentacosadiynoic acids, hexacosadiynoic acids, heptacosadiynoic acids, octacosadiynoic acids, nonacosadiynoic acids, triacontanediynoic acids, and combinations thereof.

7. The energy-sensitive adduct according to claim 6 wherein said functionalized or unfunctionalized acetylenic compound is 10,12-pentacosadiynoic acid.

8. The energy-sensitive adduct according to claim 1 wherein said substance is selected from the group consisting of polar, nonpolar, organic, inorganic, and organometallic substances.

9. The energy-sensitive adduct according to claim 8 wherein said substance is selected from the group consisting of functionalized or unfunctionalized aliphatic, alicyclic, heterocyclic, aromatic, heteroaromatic, olefinic, and polyolefinic hydrocarbons.

10. The energy-sensitive adduct according to claim 8 wherein said substance is selected from the group consisting of organic acids, organic bases, inorganic acids, inorganic bases, complex formers, crystal formers, cocrystal formers, and combinations thereof.

11. The energy-sensitive adduct according to claim 9 wherein said substance is selected from the group consisting of functionalized or unfunctionalized aliphatic amines, alicyclic amines, heterocyclic amines, aromatic amines, heteroaromatic amines, and combinations thereof.

12. The energy-sensitive adduct according to claim 11 wherein said substance is selected from the group consisting of functionalized or unfunctionalized alkyl amines, dialkyl amines, trialkyl amines, quaternary amines, pyridines, azopyridines, bipyridyls, pyrimidines, pyrazines, piperidines, bipiperidines, morpholines, and combinations thereof.

13. The energy-sensitive adduct according to claim 10 wherein said substance is selected from the group consisting of inorganic bases.

14. The energy-sensitive adduct according to claim 13 wherein said substance is selected from the group consisting of hydrides, oxides, hydroxides, cyanides, carbonates, and bicarbonates of alkali and alkaline earth metal elements, and combinations thereof.

15. The energy-sensitive adduct according to claim 1 wherein said adduct exhibits an enhanced energy-sensitivity compared to said acetylenic compound in absence of said substance.

16. The energy-sensitive adduct according to claim 1 wherein said adduct exhibits a reduced energy-sensitivity compared to said acetylenic compound in absence of said substance.

17. The energy-sensitive adduct according to claim 1 wherein said energy is derived from ionizing radiation, electromagnetic radiation, or heat.

18. The energy-sensitive adduct according to claim 17 wherein said ionizing radiation comprises gamma rays or X-rays.

19. The energy-sensitive adduct according to claim 17 wherein said electromagnetic radiation comprises visible, ultraviolet, or infrared radiation.

20. The energy-sensitive adduct according to claim 1 wherein said adduct is in the form of a salt, cocrystal, polymorph, or an amorphous solid dispersion.

21. The energy-sensitive adduct according to claim 20 wherein said adduct is in the form of a salt or a cocrystal.

22. A composition comprising an energy-sensitive adduct derived from at least one functionalized or unfunctionalized acetylenic compound having at least 25 carbons and at least one substance.

23. A radiation-sensitive device for detection or measurement of radiation comprising a radiation dose indicator comprising an energy-sensitive adduct derived from at least one functionalized or unfunctionalized acetylenic compound having at least 25 carbons and at least one substance.

24. An energy-sensitive adduct derived from 10,12-pentacosadiynoic acid and at least one substance selected from the group consisting of functionalized or unfunctionalized alkyl amines, dialkyl amines, trialkyl amines, quaternary amines, pyridines, azopyridines, bipyridyls, pyrimidines, pyrazines, piperidines, bipiperidines, morpholines, and combinations thereof.

25. A composition comprising an energy-sensitive adduct derived from 10,12-pentacosadiynoic acid and at least one substance selected from the group consisting of functionalized or unfunctionalized alkyl amines, dialkyl amines, trialkyl amines, quaternary amines, pyridines, azopyridines, bipyridyls, pyrimidines, pyrazines, piperidines, bipiperidines, morpholines, and combinations thereof.

26. A radiation-sensitive device for detection and measurement of high energy radiation comprising a radiation dose indicator comprising an energy-sensitive adduct derived from 10,12-pentacosadiynoic acid and at least one substance selected from the group consisting of functionalized or unfunctionalized alkyl amines, dialkyl amines, trialkyl amines, quaternary amines, pyridines, azopyridines, bipyridyls, pyrimidines, pyrazines, piperidines, bipiperidines, morpholines, and combinations thereof.
